(19) United States
(12) Patent Application Publication
(10) Pub. No.: US 2018/0223004 A1
(43) Pub. Date: Aug. 9, 2018

(54) POLYISOPRENE PRODUCTION METHOD

(71) Applicants: HITACHIZOSEN CORPORATION, Osaka (JP); OSAKA UNIVERSITY, Osaka (JP)

(72) Inventors: Isao YUKI, Osaka (JP); Nobuaki SUZUKI, Osaka (JP); Shinya TAKENO, Osaka (JP); Yoshihisa NAKAZAWA, Osaka (JP); Takeshi BAMBA, Osaka (JP)

(21) Appl. No.: 15/895,341

(22) PCT Filed: Jun. 22, 2016
(86) PCT No.: PCT/JP2016/068564

§ 371 Date: Feb. 13, 2018

(30) Foreign Application Priority Data
Sep. 17, 2015 (JP) 2015-184015

(51) Int. Cl. C08C 4/00; C08F 136/08; B01D 11/02

(52) U.S. Cl. CPC C08C 4/00; B01D 11/028; B01D 11/0288; C08F 136/08

(57) ABSTRACT

The present invention provides a method for producing polyisoprene including the steps of: (A) combining a plant tissue containing polyisoprene with an organic solvent at a temperature of 60 to 80° C. to prepare a polyisoprene solution; and (B) lowering the temperature of the polyisoprene solution to 0 to 30° C. to deposite the polyisoprene in the polyisoprene solution, wherein the organic solvent is ethylene glycol dimethyl ether.

### TECHNICAL FIELD

The present invention relates to a method for producing polyisoprene, and more specifically relates to a method for efficiently producing polyisoprene from a predetermined plant tissue.

### BACKGROUND ART

Polyisoprenes are high molecular compounds (isoprene polymers) produced from terrestrial higher plants. Polyisoprenes are roughly classified into cis-polyisoprenes and trans-polyisoprenes based on their three-dimensional structures.

Examples of a plant material capable of producing long-chain cis-polyisoprene include a large number of plant materials such as Hevea brasiliensis belonging to the family Euphorbiaceae, which is a natural rubber producing tree, Taraxacum koksaghyz and Parthenium argentatum belonging to the family Asteraceae, and Periploca sepium belonging to the family Apocynaceae. Meanwhile, examples of a plant material capable of producing long-chain trans-polyisoprene include only a small number of plant materials such as Eucommia ulmoides belonging to the family Eucommiaceae, and Mimusops balata and Palaquium gutta belonging to the family Sapotaceae (Non-Patent Documents 1 and 2). Of these, cis-polyisoprene produced from Hevea brasiliensis can be easily extracted, and thus it is widely used as natural rubber in commercial fields. However, regarding polyisoprene produced from the above-described plant materials other than Hevea brasiliensis, regardless of whether it is cis-polyisoprene or trans-polyisoprene, no method has been developed yet for efficiently extracting the polyisoprene from plant tissues included in the plant materials, and it cannot be said that such polyisoprene is sufficiently used in commercial fields.

Conventionally, as a method for extracting desired polyisoprene from the above-described plant materials other than Hevea brasiliensis, the most effective method is to crush a plant material containing polyisoprene, immerse the thus obtained plant tissue in an organic solvent, and elute only a polymer component.

However, according to such a conventional method, it is necessary to extract a reaction product in a stepwise manner using a large number of types of organic solvents. Accordingly, an increase in the effort and the production cost due to complexity of the solvent recycling and reaction processes is the most significant problem. For example, it is known that polyisoprene is typically soluble to chain hydrocarbons such as hexane, petroleum benzine, and petroleum ether; aromatic hydrocarbons such as toluene; chlorinated hydrocarbons such as chloroform; and cyclic ethers such as tetrahydrofuran. However, the solubility is not more than approximately 2% even in toluene, which is the best solvent. In order to extract a larger amount of polyisoprene from a certain amount of plant material containing polyisoprene, it is necessary to use a large amount of organic solvent.

For example, Patent Document 1 describes a method for producing trans-polyisoprene, by performing ethanol extraction on Eucommia ulmoides tissues, removing the extract solution, and then performing toluene treatment and toluene/methanol treatment on the remaining solid content, and causing the resultant substance to be dissolved in hot hexane and then settled. Since this method requires a large amount of many types of organic solvents and thermal energy, the cost is inevitably high, and the environmental loading is also high. Furthermore, since toluene is carcinogenic, this method is problematic also in terms of safety for operators and the like. Moreover, since a pigment component such as chlorophyll derived from the plant tissue is co-extracted with toluene, this method requires a plurality of times of additional processes for removing the pigment component, and thus the efficiency in collecting a polyisoprene component may be significantly lowered as a whole.

With the recent growing economies in developing countries, demands for products made of polymers such as rubber or plastic are more rapidly increasing. Furthermore, in view of global warming and the like, development of techniques for producing polymers not derived from fossil resources is urgently needed. There is a demand for development of techniques for producing polyisoprene from a wide variety of plant materials, through development of efficient extraction methods.

### RELATED ART DOCUMENTS

### Patent Document

Patent Document 1: Japanese Laid-Open Patent Publication No. 2004-189953

### Non-Patent Documents

Non-Patent Document 1: Trends in Biotechnology Vol. 25, 11 (2007), 522-529
Non-Patent Document 2: “Components and Physical Properties of Eucommia Elastomer”, Hitz Technical Review, Hitachi Zosen Corporation, May 2013, Vol. 74, No. 5

### SUMMARY OF INVENTION

### Problem to be Solved by Invention

The present invention solves the above-described problems, and it is an object thereof to provide a polyisoprene production method in which the number of types of organic solvents used and the amount of energy are reduced, and that provides a safer environment and improved efficiency.

### Means for Solving Problem

The present invention provides a method for producing polyisoprene comprising the steps of:

(A) combining a plant tissue containing polyisoprene with an organic solvent at a temperature of 60 to 80° C. to prepare a polyisoprene solution; and

(B) lowering the temperature of the polyisoprene solution to 0 to 30° C. to deposite the polyisoprene in the polyisoprene solution,

wherein the organic solvent is ethylene glycol dimethyl ether.

In one embodiment, the plant tissue containing polyisoprene is obtained through pre-treatment step in which a pre-treatment solvent is applied at a temperature of 10 to 30° C. to a crushed material of the plant material containing polyisoprene, wherein the pre-treatment solvent is ethylene glycol dimethyl ether.

In a further embodiment, the method of the present invention further comprises the step of:

(C) separating the deposited polyisoprene from the polyisoprene solution to obtain a recovered liquid.

In a more further embodiment, the method of the present invention further comprises the step of:

(D) returning the recovered liquid as the organic solvent to the step (A).

In a more further embodiment, the method of the present invention further comprises the step of:

(E) returning the recovered liquid as the pre-treatment solvent to the pre-treatment step.

In one embodiment, the method of the present invention further comprises the step of:

(C) separating the deposited polyisoprene from the polyisoprene solution to obtain a recovered liquid.

In one embodiment, the polyisoprene is trans-polyisoprene.

In one embodiment, the plant tissue containing polyisoprene is derived from Eucommia ulmoides.

### Effects of Invention

According to the present invention, it is possible to reduce the number of types of organic solvents used, and to efficiently produce polyisoprene from plant tissues containing polyisoprene. Furthermore, according to the method of the present invention, the organic solvents after use can be reused. Accordingly, the production efficiency can be improved, and the influence of the environmental loading can be suppressed.

### BRIEF DESCRIPTION OF DRAWINGS

FIG. 1 is a production flowchart illustrating an example of the method of the present invention.

FIG. 2 is a graph showing the molecular weight distribution of trans-polyisoprene obtained in Example 1.

### DESCRIPTION OF EMBODIMENT

Hereinafter, the present invention will be described in detail.

In the present invention, a plant tissue containing polyisoprene are combined with an organic solvent.

The term “polyisoprene” used herein refers to trans-polyisoprene (trans-polyisoprenoid) and cis-polyisoprene (cis-polyisoprenoid) essentially contained in biomass.

A plant tissue containing polyisoprene is obtained from a plant material containing polyisoprene. The plant tissue containing polyisoprene is, for example, in the form of a particle such as a crushed material or a cutting powder, obtained from dried or non-dried roots, stems (trunks), leaves, samaras (peel and seeds), and bark of the plant material, and combinations thereof.

Examples of the plant material containing polyisoprene include a plant material capable of producing cis-polyisoprene and a plant material capable of producing trans-polyisoprene. Examples of the plant material capable of producing cis-polyisoprene include Hevea brasiliensis belonging to the family Euphorbiaceae, Taraxacum koksaghyz and Parthenium argentatum belonging to the family Asteraceae, and Periploca sepium belonging to the family Apocynaceae. Examples of the plant material capable of producing trans-polyisoprene include Eucommia ulmoides belonging to the family Eucommiaceae, and Mimusops balata and Palaquium gutta belonging to the family Sapotaceae. In the present invention, Eucommia ulmoides is preferable.

There is no particular limitation on the number average molecular weight (Mn) of polyisoprene contained in the plant tissue or the plant material, but, for example, if polyisoprene is derived from Eucommia ulmoides, the number average molecular weight (Mn) is preferably 10000 to 1500000, more preferably 50000 to 1500000, and even more preferably 100000 to 1500000.

Alternatively, there is no particular limitation on the weight average molecular weight (Mw) of polyisoprene contained in the plant tissue or the plant material, but, for example, if polyisoprene is derived from Eucommia ulmoides, the weight average molecular weight (Mw) is preferably 1×10³ to 5×10⁶, more preferably 1×10⁴ to 5×10⁶, and even more preferably 1×10⁵ to 5×10⁶.

The organic solvent used in the present invention easily dissolves a wide variety of substances ranging from inorganic salts to organic polymers, and the solubility of a substance, in particular polyisoprene, to the organic solvent at a high temperature (e.g., at a heating temperature less than the boiling point) is different from that at a low temperature (e.g., at room temperature or at a cooling temperature), wherein the solubility at the high temperature is higher than the solubility at the low temperature. It is preferable that the organic solvent is safe for human bodies. There is no particular limitation on the organic solvent, but examples thereof include ethylene glycol dimethyl ether (DME).

In the present invention, the organic solvent used may be at least one type of organic solvent, but, for example, in order to solve complexity in the production process by avoiding use of a plurality of types of organic solvents, it is preferable to use one type of organic solvent (e.g., ethylene glycol dimethyl ether alone). In the present invention, the organic solvent may be any of a fresh organic solvent (i.e., that has not been yet used in the production processing as in the present invention (unused)), a recovered liquid for reuse that has been obtained through the production processing in the present invention as described later, and a combination thereof.

There is no particular limitation on the mixing proportion of the plant tissue containing polyisoprene and the organic solvent in the present invention, and, for example, any amount that allows the plant tissue to be sufficiently immersed in the organic solvent may be freely selected by those skilled in the art. The plant tissue containing polyisoprene and the organic solvent may be mixed at a proportion of preferably 300 to 3000 mL, and more preferably 400 to 1000 mL, with respect to 100 g of dry weight of the plant tissue.

In the present invention, the plant tissue containing polyisoprene and the organic solvent are combined at a predetermined temperature (e.g., heating temperature). The temperature is typically a temperature that is higher than room temperature and lower than the boiling point of the organic solvent, such as a temperature of 60 to 80° C., preferably 65 to 75° C., and more preferably 70° C. If the plant tissue containing polyisoprene and the organic solvent are combined in such a temperature range, the solubility of polyisoprene to the organic solvent increases, and polyisoprene can be easily eluted (i.e., extracted) from the plant tissue into the organic solvent.

There is no particular limitation on the time needed for the elution because it varies depending on the amount or the type of plant tissue and/or organic solvent used, but it is preferably 1 to 24 hours, and more preferably 4 to 8 hours.

In the present invention, the above-stated temperature may be applied by adding the plant tissue containing polyisoprene to the organic solvent heated in advance to a predetermined temperature and then heating the mixture in the above-stated temperature range for a predetermined period of time, or by adding the plant tissue containing polyisoprene to the organic solvent that has not been particularly heated (e.g., at room temperature) and then heating the mixture in the above-stated temperature range for a predetermined period of time.

In this manner, polyisoprene solution is prepared from a mixed liquid obtained by combining the plant tissue with the organic solvent.

In the mixed liquid, matters that are insoluble to the organic solvent, other than the polyisoprene solution, may be, for example, precipitated or floating. These insolubles are preferably removed in advance using a method (filtration, decantation, etc.) well known to those skilled in the art, so that only the polyisoprene solution is obtained.

Then, in the present invention, the temperature of the polyisoprene solution is lowered.

The temperature of the polyisoprene solution is lowered, for example, by cooling down the solution, allowing the solution to cool down (to stand), or performing a combination thereof. There is no particular limitation on the time needed for lowering the temperature, and any time length may be selected by those skilled in the art.

In the present invention, the temperature of the polyisoprene solution is lowered, for example, to 0 to 30° C., and preferably to 0 to 10° C. In the present invention, when the polyisoprene solution is obtained as described above, the organic solvent is at a high temperature (e.g., 60 to 80° C. as described above), and thus the solubility of polyisoprene to the organic solvent has been increased. However, in accordance with a decrease in the temperature of the polyisoprene solution as described above, the solubility of polyisoprene to the organic solvent is lowered. Accordingly, in accordance with a decrease in the temperature, polyisoprene insoluble to the organic solvent is deposited in the polyisoprene solution and highly pure polyisoprene can be thus obtained. If the temperature of the polyisoprene solution is set to be lower than 0° C., a cooling apparatus and the like have to be additionally provided in order to set the temperature to be lower than room temperature, which may increase the energy balance necessary for producing polyisoprene. Meanwhile, if the temperature of the polyisoprene solution is set to be higher than 30° C., the amount of polyisoprene that is deposited in accordance with a decrease in the solubility decreases, and, furthermore, a heating apparatus and the like have to be additionally provided in order to set the temperature to be higher than room temperature, which may increase the energy balance necessary for producing polyisoprene.

The deposited polyisoprene is then separated from the solution. In this manner, polyisoprene can be efficiently produced from plant tissue containing polyisoprene.

In the present invention, in order to further facilitate the deposition of polyisoprene, a predetermined amount of organic solvent contained in the polyisoprene solution may be removed in advance using an evaporation means well known to those skilled in the art, and then the temperature may be lowered to the above-stated temperature range.

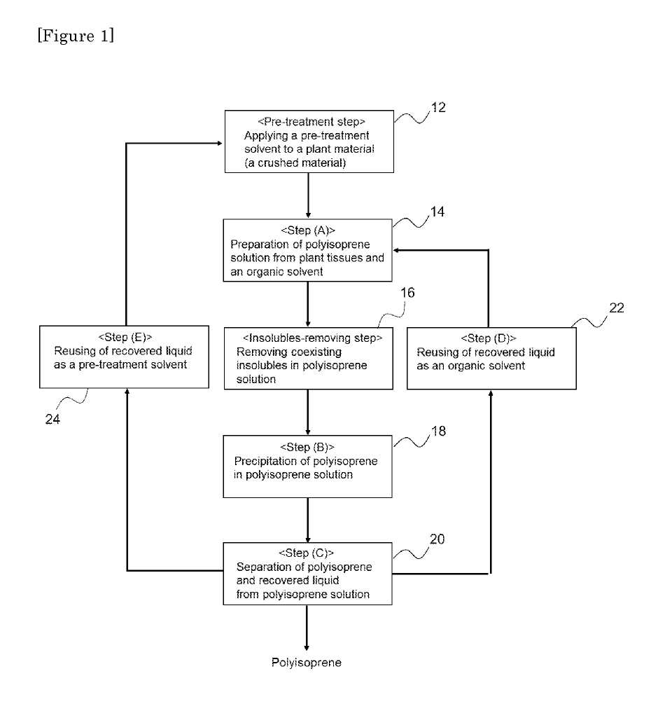

Next, a more specific example of the present invention will be described with reference to FIG. 1.

FIG. 1 is a production flowchart illustrating an example of the method of the present invention.

First, in the present invention, a pre-treatment solvent is applied to a crushed material composed of a plant material containing the polyisoprene adjusted to have an appropriate particle size (pre-treatment step 12 in FIG. 1). The crushed material is obtained by crushing the plant material into particles with a predetermined particle size, using a crushing means (e.g., a ball mill or a huller) well known to those skilled in the art. Alternatively, the crushed material may be obtained through chemical treatment (e.g., alkali treatment) or decay using microorganisms. If the plant material containing polyisoprene is crushed using such a crushing means, the tissue structure inside the plant material is broken, and thus the possibility that a polyisoprene component usually enclosed in laticifer cells or the like is brought into contact with the organic solvent in a later-described step (step (A)) can be increased. Furthermore, if the tissue structure is broken, removal of pigment components such as chlorophyll and lipid-soluble components can be easily performed in the pre-treatment step.

There is no particular limitation on the particle size (maximum particle size) of the crushed material, but, in order to improve the polyisoprene eluting efficiency in the subsequent step (A), the particle size is preferably 2 to 10 mm, and more preferably 2 to 4 mm.

The pre-treatment solvent used in the pre-treatment step 12 is the same as the above-described organic solvent (e.g., ethylene glycol dimethyl ether (DME)).

In the pre-treatment step 12, the pre-treatment solvent may be any of a fresh organic solvent (i.e., that has not been yet used in the production processing as in the present invention (unused)), a recovered liquid for reuse that has been obtained through the production processing in the present invention as described, or a combination thereof.

There is no particular limitation on the mixing proportion of the crushed material composed of the plant tissue containing polyisoprene and the pre-treatment solvent in the pre-treatment step 12, but, for example, the pre-treatment solvent may be mixed at a proportion of preferably 300 to 3000 mL, and more preferably 400 to 1000 mL, with respect to 100 g of dry weight of the crushed material.

In the pre-treatment step 12, the crushed material and the pre-treatment solvent are applied, for example, by mixing the crushed material with the pre-treatment solvent, immersing the crushed material in the pre-treatment solvent, bringing the pre-treatment solvent into contact with the crushed material through, for example, showering or spraying, or performing these methods in a combination. If the crushed material is immersed in the pre-treatment solvent, it is preferable to sufficiently stir the mixture.

In the pre-treatment step 12, the crushed material and the pre-treatment solvent are applied at a predetermined temperature. The temperature is, for example, a temperature around room temperature, preferably 30° C. or lower, more preferably 10 to 30° C., and even more preferably 20 to 30° C. If the temperature applied to the crushed material and the pre-treatment solvent is higher than 30° C., polyisoprene may be eluted from the crushed material.

There is no particular limitation on the time needed for the application because it varies depending on the amount or the type of plant material and/or organic solvent used, but it is preferably 1 to 24 hours, and more preferably 4 to 8 hours.

If the crushed material and the pre-treatment solvent are applied, pigment components (e.g., chlorophyll) and lipid-soluble components (e.g., various organic acids) contained in tissues mainly made of lignocellulose in the plant material are eluted from the crushed material and move toward and are dissolved in the pre-treatment solvent. Accordingly, the content of pigment components and lipid-soluble components in the plant material that are not necessary for obtaining targeted polyisoprene can be reduced in advance.

After the application, the pre-treatment solvent can be easily removed using a method (e.g., filtration or decantation) well known to those skilled in the art. In the present invention, this pre-treatment step may be repeatedly performed a plurality of times in order to more reliably remove the pigment components and the lipid-soluble components.

The plant tissue containing polyisoprene used in the present invention can be obtained by applying the crushed material and the pre-treatment solvent in this manner. The plant tissue may be dried or washed with a fresh pre-treatment solvent as necessary.

Then, the plant tissue containing polyisoprene and the organic solvent are combined at a predetermined temperature as described above, so that the polyisoprene solution is prepared (step (A) 14 in FIG. 1).

Then, the mixed liquid (containing the polyisoprene solution) of the plant tissue containing polyisoprene and the organic solvent obtained in the above-described step (A) 14 is separated into the polyisoprene solution and insolubles coexisting therewith, using a method such as filtration or decantation (insolubles-removing step 16 in FIG. 1). If the separation is performed through filtration, examples of a filter that can be used include a filter paper, a nonwoven fabric, a glass fiber filter, and a membrane filter. Furthermore, examples of a filtration method that can be used include natural filtration, suction filtration, pressure filtration, and centrifugal filtration.

It is preferable that the insoluble-removing step 16 is performed quickly such that the temperature of the polyisoprene solution is kept in the temperature range applied in the step (A) 14 to the extent possible. The reason for this is that, if the temperature of the polyisoprene solution is lowered, polyisoprene may be deposited and removed through the separation.

Subsequently, the temperature of the polyisoprene solution obtained in the insoluble-removing step 16 is lowered to a predetermined temperature as described above (step (B) 18 in FIG. 1).

After the step (B) 18, the polyisoprene deposited from the polyisoprene solution is separated from the solution component, using a method such as filtration or decantation (step (C) 20 in FIG. 1). If the separation is performed through filtration, examples of a filter that can be used include a filter paper, a nonwoven fabric, a glass fiber filter, and a membrane filter. Furthermore, examples of a filtration method that can be used include natural filtration, suction filtration, pressure filtration, and centrifugal filtration.

Alternatively, in the step (C) 20 in the present invention, the polyisoprene deposited from the polyisoprene solution may be directly separated using a squeezing dewatering machine or the like.

In the present invention, polyisoprene separated through the step (C) 20 can be obtained at a high purity and a high yield, and the solution component can be recovered as a recovered liquid. The recovered liquid may be disposed of as it is, or may be reused for the method of the present invention, for example, as follows.

The recovered liquid contains polyisoprene dissolved therein without being deposited at the temperature set in the step (B) 18, but it is mainly made of the same components as those in the pre-treatment solvent used in the pre-treatment step 12 and/or the organic solvent used in the step (A) 14 described above. Accordingly, in the present invention, for example, the recovered liquid can be returned to the step (A) 14, as the organic solvent (step (D) 22 in FIG. 1). Alternatively, in the present invention, for example, the recovered liquid can be returned to the pre-treatment step 12 instead of the step (D) 22 or in addition to the step (D) 22, as the pre-treatment solvent (step (E) 24 in FIG. 1).

The amount of recovered liquid that is disposed of can be reduced to the extent possible through the step (D) 22 and/or the step (E) 24. The polyisoprene still dissolved and remaining in the recovered liquid even after the step (B) 18 can be deposited through reuse of the recovered liquid, without being disposed of.

In the present invention, there is no particular limitation on the number of times (the number of repetitions) for repeatedly reusing the recovered liquid in the step (D) 22 and/or the step (E) 24, and any number of times may be selected by those skilled in the art.

In this manner, it is possible to obtain highly pure polyisoprene at a high yield from plant tissue containing polyisoprene. According to the method of the present invention, the amount of organic solvent (and pre-treatment solvent) used can be reduced to the extent possible, and not so many types of such solvents are required. Furthermore, the method of the present invention can be applied to production of trans-polyisoprene and cis-polyisoprene, and use of a large amount of thermal energy can be avoided in the production of polyisoprene.

### EXAMPLES

Hereinafter, the present invention will be more specifically described by way of examples. However, the present invention is not limited to these examples.

### Example 1

Samaras of a temperate tree Eucommia ulmoides capable of producing trans-polyisoprene harvested in the autumn of 2014 were sufficiently dried. Then, the dried samaras were separated into seeds and peel inside a huller (it is known that Eucommia ulmoides peel contains trans-polyisoprene at a proportion of about 10 to 25% by weight in the dry weight). The peel obtained by this treatment was crushed into the shape of particles with a maximum particle size of about 2 mm. This crushed peel was used as a sample as follows.

First, 10 g of the thus obtained sample was placed in a round bottom flask, about 250 mL of ethylene glycol dimethyl ether was added thereto as a solvent at room temperature, and the mixture was stirred using a stirrer at 120 to 180 rpm at room temperature for 6 hours.

Then, the solvent was taken out of the round bottom flask through N₂ compression using a cannular, 120 mL of ethylene glycol dimethyl ether was added to the residue, and the content was stirred with rotation using a stirrer for several seconds, so that the sample was washed. The treatment from removing the solvent to washing was repeated three times. After the washing, the sample inside the round bottom flask was vacuum dried for 15 hours.

Then, 99 g (110 mL) of ethylene glycol dimethyl ether was added to 10 g of the vacuum dried sample, and the mixture was heated at 60° C. and stirred for 6 hours. Accordingly, trans-polyisoprene contained in the Eucommia ulmoides peel was completely dissolved in the solvent (ethylene glycol dimethyl ether).

The obtained solution was heated at 65° C. and filtered through a nonwoven fabric with a filtration precision of approximately 100 μm, so that insolubles such as lignocellulose were removed.

Meanwhile, the filtrate was placed in another round bottom flask, and was allowed to stand at room temperature (20 to 30° C.). When the filtrate was allowed to stand for 10 minutes, it was visually seen that deposition of trans-polyisoprene that had dissolved therein was started. When the filtrate was allowed to stand for about 1 hour, no more increase in the deposition amount was observed, that is, it was seen that deposition of trans-polyisoprene was almost completed. The filtrate was continuously allowed to stand thereafter, and, after 12 hours after the filtration, deposited trans-polyisoprene was collected at room temperature through filtration using a nonwoven fabric with a filtration precision of approximately 100 μm.

The collected trans-polyisoprene was placed in another container, and 20 mL of ethylene glycol dimethyl ether was added thereto, and the container was rotated for several seconds, so that the content was stirred and washed. The treatment from adding ethylene glycol dimethyl ether to washing was repeated three times. After the washing, the content was vacuum dried for 12 hours, and thus 1.77 g of white fiber-like trans-polyisoprene was obtained (yield 17.7%).

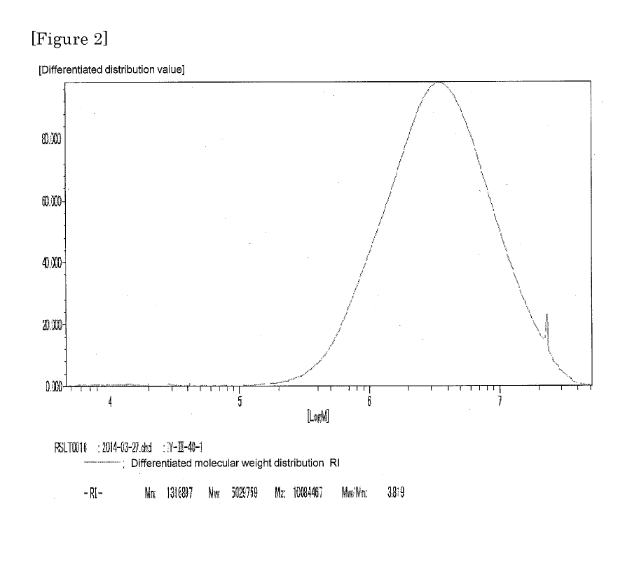

The molecular weight distribution of the thus obtained trans-polyisoprene was measured using size exclusion chromatography. FIG. 2 shows the result. Furthermore, the number average molecular weight and the weight average molecular weight of the polyisoprene were measured. The number average molecular weight was 1316897, and the weight average molecular weight was 5029759. Accordingly, it was seen that trans-polyisoprene can be obtained from Eucommia ulmoides samaras.

### INDUSTRIAL APPLICABILITY

According to the present invention, it is possible to easily obtain polyisoprene from a predetermined plant material, while reducing the number of types and the amount of organic solvents used, to the extent possible. The method of the present invention is useful in various technical fields (e.g., a wide variety of fields involving automotive industries, consumer electronics boards, fuel cells, insulating thin films, quake-free materials, sound insulation materials, biofuels, etc.) in which polyisoprene is needed.

### LIST OF REFERENCE NUMERALS

12 Pre-treatment step
14 Step (A)
16 Insolubles-removing step
18 Step (B)
20 Step (C)
22 Step (D)
24 Step (E)

1. A method for producing polyisoprene comprising the steps of:
(A) combining a plant tissue containing polyisoprene with an organic solvent at a temperature of 60 to 80° C. to prepare a polyisoprene solution; and
(B) lowering the temperature of the polyisoprene solution to 0 to 30° C. to deposite the polyisoprene in the polyisoprene solution, thereby producing deposited polyisoprene;
wherein the organic solvent is ethylene glycol dimethyl ether.

2. The method of claim 1, wherein the plant tissue containing polyisoprene is obtained through a pre-treatment step in which a pre-treatment solvent is applied at a temperature of 10 to 30° C. to a crushed material of the plant tissue containing polyisoprene, wherein the pre-treatment solvent is ethylene glycol dimethyl ether.

3. The method of claim 2, further comprising the step of:
(C) separating the deposited polyisoprene from the polyisoprene solution to obtain a recovered liquid.

4. The method of claim 3, further comprising the step of:
(D) returning the recovered liquid as the organic solvent to the step (A).

5. The method of claim 3, further comprising the step of:
(E) returning the recovered liquid as the pre-treatment solvent to the pre-treatment step.

6. The method of claim 1, further comprising the step of:
(C) separating the deposited polyisoprene from the polyisoprene solution to obtain a recovered liquid.

7. The method of claim 1, wherein the polyisoprene is trans-polyisoprene.

8. The method of claim 1, wherein the plant tissue containing polyisoprene is derived from Eucommia ulmoides.

9. The method of claim 4, further comprising the step of:
(E) returning the recovered liquid as the pre-treatment solvent to the pre-treatment step.
